(19) United States
(12) Patent Application Publication
(10) Pub. No.: US 2021/0012084 A1
(43) Pub. Date: Jan. 14, 2021

(54) FINGERPRINT COLLECTION METHOD AND ELECTRONIC DEVICE

(71) Applicant: Acer Incorporated, New Taipei City (TW)

(72) Inventors: Chia-Yu Sun, New Taipei City (TW); Chih-Chiang Chen, New Taipei City (TW)

(73) Assignee: Acer Incorporated, New Taipei City (TW)

(21) Appl. No.: 16/819,174

(22) Filed: Mar. 16, 2020

(30) Foreign Application Priority Data
Jul. 13, 2019 (TW) 108124810

(51) Int. Cl. G06K 9/00

(52) U.S. Cl. CPC G06K 9/00026; G06K 9/00926

(57) ABSTRACT

A fingerprint collection method and an electronic device are provided according to embodiments of the disclosure. The electronic device includes a fingerprint sensor and a touch panel, and the method includes: obtaining fingerprint information of a finger through the fingerprint sensor; obtaining sensing information of the finger with respect to the touch panel through the touch panel during a time period in which the fingerprint information is obtained; and storing fingerprint authentication information corresponding to the finger according to the fingerprint information and the sensing information.

### CROSS-REFERENCE TO RELATED APPLICATION

This application claims the priority benefit of Taiwan application serial no. 108124810, filed on Jul. 13, 2019. The entirety of the above-mentioned patent application is hereby incorporated by reference herein and made a part of this specification.

### TECHNICAL FIELD

The invention relates to a fingerprint collection technique, and more particularly to a fingerprint collection method and an electronic device.

### BACKGROUND

With the advancement of technology, the fingerprint authentication mechanism for verifying user identity by fingerprint has also become popular. In order to activate the fingerprint authentication mechanism, an electronic device will first perform a fingerprint registration procedure to store fingerprint information of a user. Generally, in the fingerprint registration procedure, the system prompts the user to touch a sensor multiple times so as to randomly record multiple feature points in the fingerprint of the user. However, in practice, even after the user has repeatedly touched the sensor multiple times, the system is still unable to collect enough feature points sometimes. Consequently, the fingerprint registration procedure fails and/or wastes too much time.

### SUMMARY

The invention provides a fingerprint collection method and an electronic device capable of effectively improving a fingerprint collection efficiency of the electronic device.

An embodiment of the invention provides a fingerprint collection method for an electronic device. The electronic device has a fingerprint sensor and a touch panel, and the fingerprint collection method includes: obtaining fingerprint information of a finger through the fingerprint sensor; obtaining sensing information of the finger with respect to the touch panel through the touch panel during a time period in which the fingerprint information is obtained; and storing fingerprint authentication information corresponding to the finger according to the fingerprint information and the sensing information.

Another embodiment of the invention provides an electronic device, which includes a fingerprint sensor, a touch panel and a processor. The processor is coupled to the fingerprint sensor and the touch panel. The processor is configured to obtain fingerprint information of a finger through the fingerprint sensor. The processor is further configured to obtain sensing information of the finger with respect to the touch panel through the touch panel during a time period in which the fingerprint information is obtained. The processor is further configured to store fingerprint authentication information corresponding to the finger according to the fingerprint information and the sensing information.

Based on the above, the electronic device has the fingerprint sensor and the touch panel. When the fingerprint sensor of the fingerprint of the user is obtained through the fingerprint sensor, the sensing information of the finger with respect to the touch panel may be synchronously obtained. Then, the fingerprint authentication information corresponding to the finger may be stored according to the fingerprint information and the sensing information. As a result, by using the fingerprint sensor to assist the fingerprint sensor to perform the fingerprint collection, fingerprint collection ability and efficiency of the electronic device may both be significantly improved.

To make the above features and advantages of the disclosure more comprehensible, several embodiments accompanied with drawings are described in detail as follows.

### BRIEF DESCRIPTION OF THE DRAWINGS

FIG. 1 is a functional block diagram illustrating an electronic device according to an embodiment of the invention.

FIG. 2 is a schematic diagram illustrating appearance of the electronic device according to an embodiment of the invention.

FIG. 3 is a schematic diagram illustrating a fingerprint registration operation according to an embodiment of the invention.

FIG. 4 is a schematic diagram illustrating sensing information of a finger with respect to a touch panel according to an embodiment of the invention.

FIG. 5A to FIG. 5D are schematic diagrams illustrating different contact states and corresponding sensing information according to an embodiment of the invention.

FIG. 6 is a schematic diagram illustrating an indication unit according to an exemplary embodiment of the invention.

FIG. 7 is a schematic diagram illustrating a fingerprint collection operation according to an embodiment of the invention.

### DETAILED DESCRIPTION

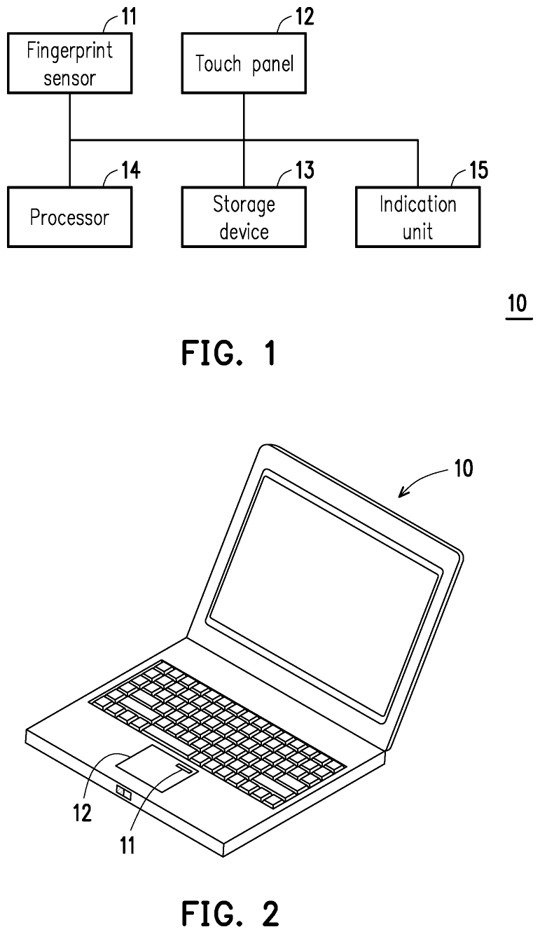

FIG. 1 is a functional block diagram illustrating an electronic device according to an embodiment of the invention. With reference to FIG. 1, an electronic device 10 includes a fingerprint sensor 11, a touch panel 12, a storage device 13 and a processor 14. The fingerprint sensor 11 is configured to sense fingerprint information of a finger of a user. For example, the fingerprint sensor 11 may be a capacitive fingerprint sensor or an optical fingerprint sensor, and the invention does not limit the type of the fingerprint sensor 11. For example, the user can place the finger on a sensing surface of the fingerprint sensor 11, and the fingerprint sensor 11 can sense the fingerprint information of the user through the sensing surface.

The touch panel 12 is configured to sense that the finger of the user approaches and/or contacts and generate corresponding sensing information. For example, the sensing information may include voltage changes, current changes, capacitance changes and/or resistance changes to reflect a contact position and/or a contact area of the finger of the user on the touch panel 12. For example, the touch panel 12 may be a resistive touch panel or a capacitive touch panel, and the invention does not limit the type of the touch panel 12. During operations of the electronic device 10, the user can input a control signal through the touch panel 12 to instruct the electronic device 10 to perform a corresponding action.

The data storage device 13 is configured to store data. For example, the storage device 13 may include various non-volatile storage circuits, such as a conventional hard disk, a solid state hard disk and/or a flash memory. Data stored in the storage device 13 will not lost due to the power of the electronic device 10 being cut off. For example, the storage device 13 can store information including registered fingerprint information (a.k.a. fingerprint authentication information) and program codes required during operations of the electronic device 11. In addition, the storage device 13 can also include a non-volatile storage circuit such as a random access memory (RAM) to store temporary information generated during operations of the electronic device 11.

The processor 14 is coupled to the fingerprint sensor 11, the touch panel 12 and the storage device 13. The processor 14 may be, for example, a central processing unit (CPU) or other programmable devices for general purpose or special purpose such as a microprocessor and a digital signal processor (DSP), a programmable controller, an application specific integrated circuit (ASIC), a programmable logic device (PLD) or other similar devices or a combination of above-mentioned devices.

In an embodiment, the processor 14 is only responsible for operations related to the fingerprint authentication mechanism, such as fingerprint sensing, fingerprint registration, fingerprint authentication, and the like. In an embodiment, the processor 14 may also be responsible for overall operation or other operations of the electronic device 11. In an embodiment, the electronic device 10 further includes other types of input/output (I/O) devices and power supply devices. For example, the input/output device may include a mouse, a keyboard, a display, a microphone, a speaker, or a network interface card, etc., and the type of the input/output device is not limited thereto. Further, the power supply device may include various power supplies or batteries.

In the following embodiments, the electronic device 10 is described using a notebook computer as an example. However, in another embodiment, the electronic device 10 may also be a variety of electronic devices, such as a smart phone, a tablet computer, a digital photo frame, a desktop computer, or an e-book reader. The invention is not limited in this regard.

FIG. 2 is a schematic diagram illustrating appearance of the electronic device according to an embodiment of the invention. With reference to FIG. 2, the electronic device 10 is disposed with the fingerprint sensor 11 and the touch panel 12. In this embodiment, the fingerprint sensor 11 is disposed on the touch panel 12. For example, the fingerprint sensor 11 may be disposed in an upper right corner of the touch panel 12, as shown in FIG. 2. Alternatively, a sensing range of the fingerprint sensor 11 may also be regarded as being included in a sensing range of the touch panel 12. It should be noted that in another embodiment, the fingerprint sensor 11 may also be disposed at other surface positions of the touch panel 12 (e.g., an upper left corner or a lower right corner), which are not limited by the invention.

In an embodiment, the processor 14 can perform a fingerprint registration operation (a.k.a. a fingerprint collection operation) to collect and store the fingerprint authentication information of the user. The fingerprint authentication information may be stored in the storage device 13. The stored fingerprint authentication information can be used to verify a user identity in the fingerprint authentication operation to perform power-on, login, and/or other functions of the electronic device 10 that require identity authentication. For example, after the fingerprint registration operation is completed, when power-on, login, and/or other functions of the electronic device 10 that require identity authentication need to be performed, the user can place the finger on the fingerprint sensor 11 to input the fingerprint information of the user. The processor 14 can compare the fingerprint information input by the user with the fingerprint authentication information. If the fingerprint information input by the user matches the fingerprint authentication information, the processor 14 is then allowed to execute of procedures requested by the user. Otherwise, if the fingerprint information input by the user does not match the fingerprint authentication information, the processor 14 can refuse to execute the subsequent procedure.

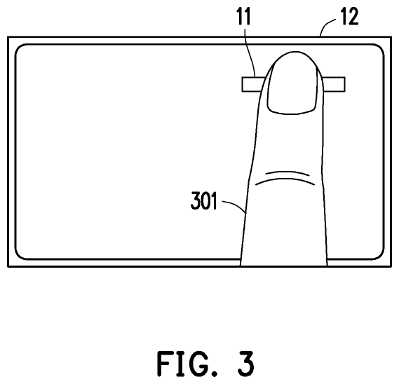

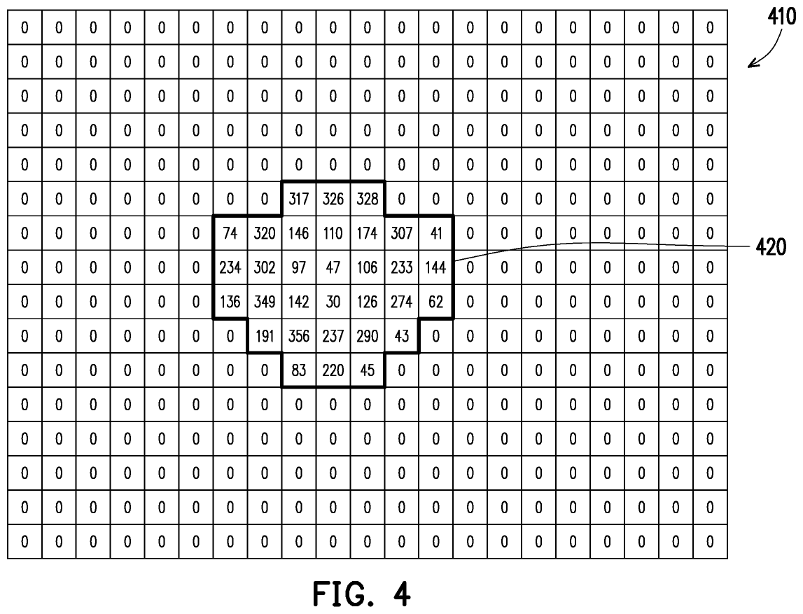

FIG. 3 is a schematic diagram illustrating a fingerprint registration operation according to an embodiment of the invention. With reference to FIG. 3, in the fingerprint registration operation, the user can place a finger 301 on the sensing surface of the fingerprint sensor 11. At this time, the processor 14 can obtain the fingerprint information of the finger 301 through the fingerprint sensor 11. On the other hand, in the fingerprint registration operation, the processor 14 can synchronously obtain the sensing information of the finger 301 with respect to the touch panel 12 through the touch panel 12. For example, during a time period in which the fingerprint information of the finger 301 is obtained by the processor 14 through the fingerprint sensor 11, as the finger 301 approaching and/or contacting sensing units (e.g., capacitor units) located around the fingerprint sensor 11 in the touch panel 12 at the same time, voltage changes, current changes, capacitance changes and/or resistance changes (i.e., the sensing information) may be generated on the sensor units. According to the sensing information, the processor 14 can obtain a contact state of the finger 301 on the fingerprint sensor 11 (and the touch panel 12). For example, the contact state may include a contact area and/or a contact shape of the finger 301.

FIG. 4 is a schematic diagram illustrating sensing information of a finger with respect to a touch panel according to an embodiment of the invention. With reference to FIG. 3 and FIG. 4, it is assumed that the touch panel 12 includes the sensing units arranged in mesh. Sensing information 410 may be used to represent a sensing value of each of the sensing units. For example, the sensing value may be a voltage value, a current value, a resistance value or a capacitance value, depending on actual needs. When no sensing information is sensed (e.g., the finger 301 is not approaching touch panel 12), each of the sensing values in the sensing information 410 may be zero (or some of the sensing values may not be zero due to a small amount of noise).

When the user touches the fingerprint sensor 11 with the finger 301 in a manner similar to that of FIG. 3, the finger 301 can cause changes in the sensed values of the sensing units in a sensing range 420, as shown in FIG. 4. For example, the sensing values of the sensing units in the sensing range 420 may all be values greater than zero. The greater sensing value can represent that a contact distance between the finger 301 and the touch panel 12 is closer and/or a force of the finger 301 acting on the touch panel 12 is stronger. In other words, the sensing information 410 can reflect the contact state of the finger 301 on the fingerprint sensor 11 during the time period in which the fingerprint information of the finger 301 is obtained through the fingerprint sensor 11. In the fingerprint registration operation, the processor 14 can store fingerprint authentication information corresponding to the finger 301 according to the obtained fingerprint information and the obtained sensing information.

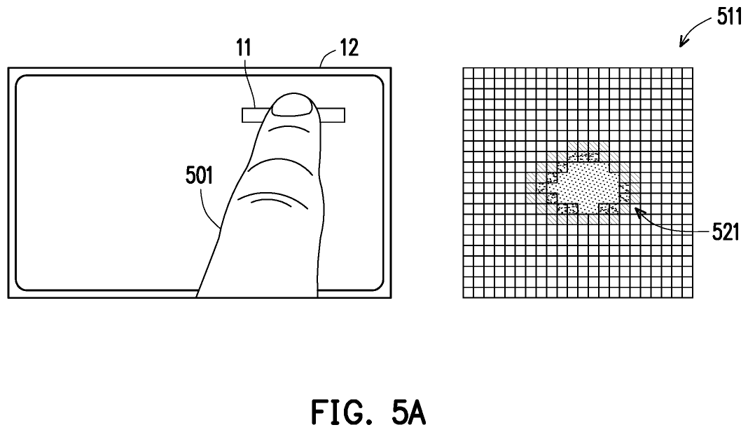

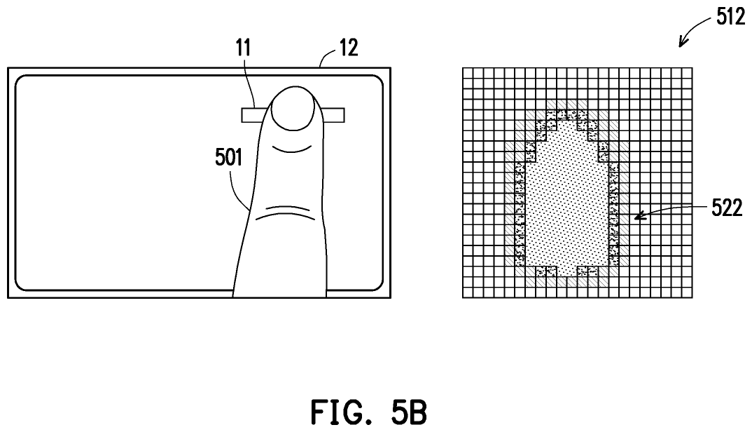

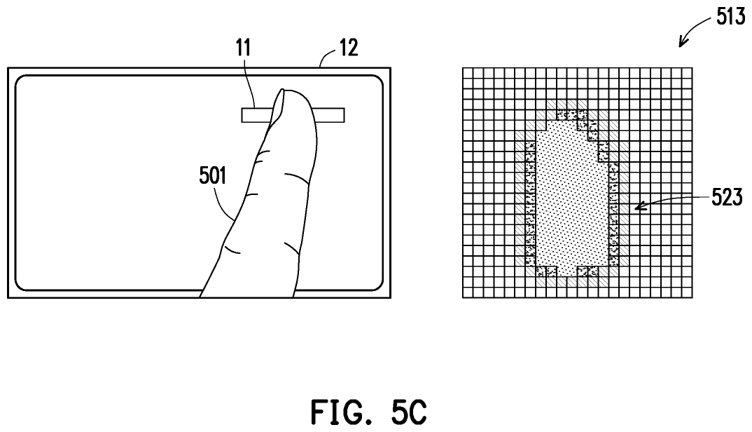

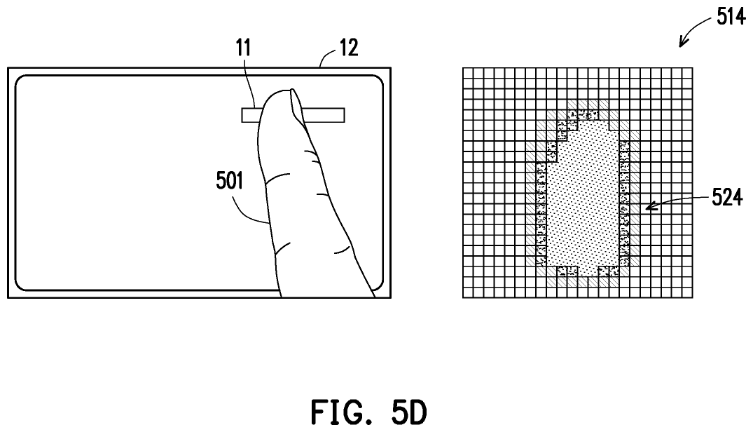

FIG. 5A to FIG. 5D are schematic diagrams illustrating different contact states and corresponding sensing information according to an embodiment of the invention. With reference to FIG. 5A, when a finger 501 contacts the touch panel 12 with a small frontal range of fingertip, sensing information 511 may be generated. In particular, in the sensing information 511, sensing values in a sensing range 521 are changed greatly to reflect the current contact state of the finger 501.

With reference to FIG. 5B, when the finger 501 contacts the touch panel 12 with a larger frontal range of fingertip, sensing information 512 may be generated. In particular, in the sensing information 512, sensing values in a sensing range 522 are changed greatly to reflect the current contact state of the finger 501.

With reference to FIG. 5C, when the finger 501 contacts the touch panel 12 with a left side of fingertip, sensing information 513 may be generated. In particular, in the sensing information 513, sensing values in a sensing range 523 are changed greatly to reflect the current contact state of the finger 501.

With reference to FIG. 5D, when the finger 501 contacts the touch panel 12 with a right side of fingertip, sensing information 514 may be generated. In particular, in the sensing information 514, sensing values in a sensing range 524 are changed greatly to reflect the current contact state of the finger 501.

In other words, in the embodiment of FIG. 5A to FIG. 5D, areas and/or shapes of the sensing ranges 521 to 524 may reflect that the contact surfaces of the finger 501 on the touch panel 12 are the small frontal range of fingertip, the larger frontal range of fingertip, the left side of fingertip and the right side of fingertip, respectively. Nonetheless, the type of contact portion of the finger that the sensing information can reflect is not limited to the above.

In an embodiment, the processor 14 can use the sensing information of the touch panel 12 to assist in stitching the fingerprint information of different finger portions. Taking FIG. 5A to FIG. 5D as an example, it is assumed that the sensing information 511 to 514 are sequentially obtained during time periods that the sensing information of four different portions of the finger 501 are continuously sensed through the fingerprint sensor 11. The processor 14 can associate the sensed fingerprint information corresponding to the finger portions of FIG. 5A to FIG. 5D with the sensing information 511 to 514, respectively. According to the sensing information 511 to 514, the processor 14 can obtain the finger portions corresponding to the four fingerprint information and/or relative positions of the finger portions. According to the finger portions corresponding to the four fingerprint information and/or the relative positions of the finger portions, the processor 14 can automatically stitch the four fingerprint information into synthetic fingerprint information. For example, the synthetic fingerprint information can include the fingerprint information sensed from gestures in FIG. 5A to FIG. 5D. The processor 14 can store the synthetic fingerprint information as at least partial information of the fingerprint authentication information corresponding to the finger 501.

In an embodiment, compared to a conventional finger stitching performed simply according to the obtained fingerprint information, a corresponding finger stitching performed by confirming the finger portions according to the synchronously obtained sensing information can provide a higher reliability and/or improve a fingerprint stitching efficiency. Here, it should be noted that, FIG. 5A to FIG. 5D are merely examples. In other embodiments, the processor 14 can also combine the corresponding fingerprint information according to the sensing information generated by more finger portions on the touch panel 12, and details regarding the same are not repeated herein.

In an embodiment, the processor 14 can also obtain a fingerprint collection degree corresponding to one specific finger (e.g., the finger 501 of FIG. 5) according to the sensing information. Taking FIG. 5A to FIG. 5D as an example, the sensing information 511 to 514 may correspond to four different finger portions. In the fingerprint registration operation, if the sensing information 511 is obtained and the sensing information 512 to 514 are not yet obtained, the processor 14 can determine that the current fingerprint collection degree is, for example, 20%. If the sensing information 511 and 512 are obtained and the sensing information 513 and 514 are not yet obtained, the processor 14 can determine that the current fingerprint collection degree is, for example, 60%. If the sensing information 511 to 513 are obtained and the sensing information 514 is not yet obtained, the processor 14 can determine that the current fingerprint collection degree is, for example, 80%. If the sensing information 511 to 514 are all obtained, the processor 14 can determine that the current fingerprint collection degree is, for example, 100%.

Returning to FIG. 1, in an embodiment, the electronic device 10 may further include an indication unit 15. The indication unit 15 is coupled to the processor 14. The indication unit 15 may include various types of signal output devices, such as a display, a speaker, or various types of light-emitting elements. The processor 14 can output a prompt message related to the fingerprint collection degree through the indication unit 15.

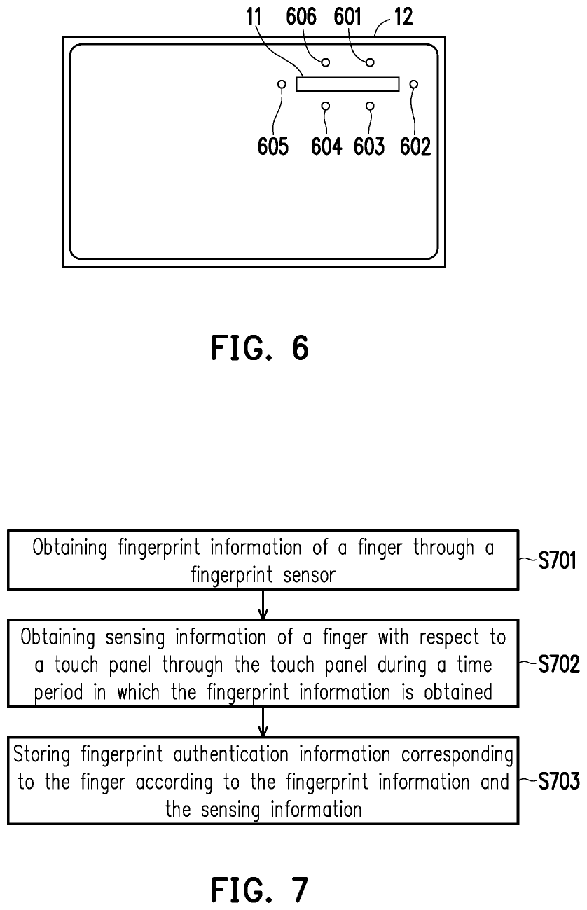

FIG. 6 is a schematic diagram illustrating an indication unit according to an exemplary embodiment of the invention. With reference to FIG. 1 and FIG. 6, in an embodiment, the indication unit 15 includes light-emitting elements 601 to 606. The light-emitting elements 601 to 606 may be disposed on a surface of the touch panel 12 and located around the fingerprint sensor 11, as shown in FIG. 6.

In the fingerprint registration operation, the processor 14 can output the prompt message related to the determined fingerprint collection degree through the light-emitting elements 601 to 606. For example, the processor 14 can adjust light-emitting states of the light-emitting elements 601 to 606 to reflect the fingerprint collection degree. For example, the total number of the light-emitting elements 601 to 606 currently emitting light may be positively correlated to the fingerprint collection degree. For example, when the fingerprint registration operation is just activated, none of the light-emitting elements 601 to 606 emits light. In response to the fingerprint information of the different portions of the same finger being gradually collected, the fingerprint collection degree can be gradually increased and the light-emitting elements 601 to 606 can be sequentially illuminated. In this way, since the user can learn of a current fingerprint progress according to the light-emitting states of the light-emitting elements 601 to 606, a user experience can be improved.

It should be noted that the total number, the control manner and the arrangement manner of the light-emitting elements 601 to 606 in FIG. 6 are all examples, and are not intended to limit the invention. In another embodiment, the total number, the control manner, and the arrangement manner of the light-emitting elements 601 to 606 may be adjusted to meet practical requirements.

In an embodiment, the indication unit 15 may also include a display of the electronic device 10 (e.g., a monitor of the notebook computer of FIG. 2). The processor 14 can control the indication unit 15 to directly display the prompt message related to the fingerprint collection degree. For example, the monitor of the notebook computer may display the current fingerprint collection degree to be 20% or 40%.

In an embodiment, according to the obtained sensing information, the processor 14 can also determine fingerprint information of a finger portion that is currently lacking. For example, in the embodiment of FIG. 5A to FIG. 5D, if the sensing information 511 to 513 are already obtained (i.e., the fingerprint information of the finger 501 on the front side of fingertip and the left side of fingertip are all obtained), the processor 14 can display the corresponding prompt message through the indication unit 15 (e.g., the monitor of the notebook computer of FIG. 2) to notify the user that the fingerprint information of the finger 501 on the right side of fingertip (corresponding to the sensing information 524) is currently lacking. In this way, the user can intuitively rotate or move the finger according to indication of the indication unit 15 to input the fingerprint information of the finger portion that is lacking. Compared to a conventional approach that the user needs to blindly rotate and move the finger, the embodiment of the invention can effectively improve an execution efficiency of the fingerprint registration operation.

FIG. 7 is a schematic diagram illustrating a fingerprint collection operation according to an embodiment of the invention. With reference to FIG. 7, in step S701, fingerprint information of a finger is obtained through the fingerprint sensor. In step S702, sensing information of the finger with respect to the touch panel is obtained through the touch panel during a time period in which the fingerprint information is obtained. In step S703, fingerprint authentication information corresponding to the finger is stored according to the fingerprint information and the sensing information.

Each step in FIG. 7 is described in detail as the above, and is thus not repeated hereinafter. It should be noted that, each step in FIG. 7 may be implemented as a plurality of program codes or circuits, which are not particularly limited by the invention. Moreover, the method of FIG. 7 may be used in combination with the above exemplary embodiments or may be used alone separately, and the invention is not limited thereto.

In summary, when the fingerprint sensor of the fingerprint of the user is obtained through the fingerprint sensor, the sensing information of the finger with respect to the touch panel may be synchronously obtained. Then, the fingerprint authentication information corresponding to the finger may be stored according to the fingerprint information and the sensing information. As a result, by using the fingerprint sensor to assist the fingerprint sensor to perform the fingerprint collection, fingerprint collection ability and efficiency of the electronic device may both be significantly improved. In addition, compared to a conventional approach that the user needs blindly rotate and move the finger, the embodiment of the invention can further accurately guide the user to complete the fingerprint registration through the prompt message to further improve the execution efficiency of the fingerprint registration operation.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

1. A fingerprint collection method for an electronic device, the electronic device having a fingerprint sensor and a touch panel, the fingerprint collection method comprising:
obtaining fingerprint information of a finger through the fingerprint sensor;
obtaining sensing information of the finger with respect to the touch panel through the touch panel during a time period in which the fingerprint information is obtained; and
storing fingerprint authentication information corresponding to the finger according to the fingerprint information and the sensing information.

2. The fingerprint collection method according to claim 1, wherein the sensing information reflects a contact state of the finger on the fingerprint sensor during the time period in which the fingerprint information is obtained.

3. The fingerprint collection method according to claim 1, wherein the fingerprint information comprises first fingerprint information and second fingerprint information, the sensing information comprises first sensing information and second sensing information, the first sensing information is obtained during a time period in which the first fingerprint information is obtained through the fingerprint sensor, the second sensing information is obtained during a time period in which the second fingerprint information is obtained through the fingerprint sensor, and the step of storing the fingerprint authentication information corresponding to the finger according to the fingerprint information and the sensing information comprises:
stitching the first fingerprint information and the second fingerprint information into synthetic fingerprint information according to the first sensing information and the second sensing information; and
storing the synthetic fingerprint information as at least partial information of the fingerprint authentication information.

4. The fingerprint collection method according to claim 1, wherein the electronic device further comprises an indication unit, and the fingerprint collection method further comprises:
obtaining a fingerprint collection degree corresponding to the finger according to the sensing information; and
outputting a prompt message related to the fingerprint collection degree through the indication unit.

5. The fingerprint collection method according to claim 4, wherein the indication unit comprises at least one light-emitting element, and the step of outputting the prompt message related to the fingerprint collection degree through the indication unit comprises:
adjusting a light-emitting state of the at least one light-emitting element to reflect the fingerprint collection degree.

6. An electronic device, comprising:
a fingerprint sensor;
a touch panel; and
a processor coupled to the fingerprint sensor and the touch panel,
wherein the processor is configured to obtain fingerprint information of a finger through the fingerprint sensor,
the processor is further configured to obtain sensing information of the finger with respect to the touch panel through the touch panel during a time period in which the fingerprint information is obtained, and
the processor is further configured to store fingerprint authentication information corresponding to the finger according to the fingerprint information and the sensing information.

7. The electronic device according to claim 6, wherein the sensing information reflects a contact state of the finger on the fingerprint sensor during the time period in which the fingerprint information is obtained.

8. The electronic device according to claim 6, wherein the fingerprint information comprises first fingerprint information and second fingerprint information, the sensing information comprises first sensing information and second sensing information, the first sensing information is obtained during a time period in which the first fingerprint information is obtained through the fingerprint sensor, the second sensing information is obtained during a time period in which the second fingerprint information is obtained through the fingerprint sensor, and the operation where the processor stores the fingerprint authentication information corresponding to the finger according to the fingerprint information and the sensing information comprises:
stitching the first fingerprint information and the second fingerprint information into synthetic fingerprint information according to the first sensing information and the second sensing information; and
storing the synthetic fingerprint information as at least partial information of the fingerprint authentication information.

9. The electronic device according to claim 6, further comprising:
an indication unit coupled to the processor,
wherein the processor is further configured to obtain a fingerprint collection degree corresponding to the finger according to the sensing information, and
the processor is further configured to output a prompt message related to the fingerprint collection degree through the indication unit.

10. The electronic device according to claim 9, wherein the indication unit comprises at least one light-emitting element, and the operation where the processor outputs the prompt message related to the fingerprint collection degree through the indication unit comprises:
adjusting a light-emitting state of the at least one light-emitting element to reflect the fingerprint collection degree.
